(19) United States
(12) Patent Application Publication
(10) Pub. No.: US 2026/0186097 A1
(43) Pub. Date: Jul. 2, 2026

(54) Front-End for Full-Duplex Below Noise Radar in a Wireless Communication Device

(71) Applicant: Telefonaktiebolaget LM Ericsson (publ), Stockholm (SE)

(72) Inventors: Henrik Sjöland, Lund (SE); Ashkan Kalantari, Malmö (SE); Andres Reial, Höllviken (SE); Gang Zou, Lund (SE); Magnus Sandgren, Staffanstorp (SE)

(21) Appl. No.: 18/867,751

(22) PCT Filed: May 25, 2022
(86) PCT No.: PCT/EP2022/064289

§ 371 Date: Nov. 20, 2024

(51) Int. Cl. G01S 7/00; G01S 7/282; G01S 7/285

(52) U.S. Cl. CPC G01S 7/006; G01S 7/282; G01S 7/285

(57) ABSTRACT

A wireless device is configured to transmit radar signals at extremely low spectral density so that the receiver can be operated at the same time without saturating and thereby enabling full-duplex operation. To achieve sufficient range, beamforming is used together with a very long correlation time for detection of the radar signal, in which case the receiver can resolve backscattered or reflected radar signals far below the noise floor, while the bandwidth of the transmitted radar signal can be very high. The wide bandwidth enables the wireless device to maintain a low power spectral density while increasing output power, and also increase the depth resolution. The extremely low power spectral density even in the transmission beam direction makes the probability that communication will be disturbed very low. The high bandwidth calls for digital filters for both transmitted and received signals to equalize the radar frequency response characteristics of the radio unit.

### TECHNICAL FIELD

The present disclosure relates generally wireless communication devices with radar capability and, more particularly, to a front-end circuit for a wireless communication device with radar functionality.

### BACKGROUND

There is a need for radar functionality in wireless devices, such as mobile phones, and in wireless network equipment like radio dots and base-stations. In addition to communication, the equipment can then perform radar functions to sense the stationary and moving objects in the environment. The information obtained by sensing can be used by many different applications, such as safety and navigation. It is desirable to reuse the wireless communication modem to implement the radar functionality to reduce the design complexity as well as the number of components. It is also desirable to share the frequency resources between radar and wireless communication so that the radar functionality can be introduced with minimum degradation of the wireless communication quality and availability.

Published PCT application WO 2020/249314 to Agardh et al. titled “LOW POWER RADAR IN RADIO COMMUNICATION TERMINAL” discloses a wireless communication terminal that uses the same chipset for both wireless communications and radar probing. Agardh notes that radar probing can interfere with wireless communications and degrade the quality of communication signals. Agardh proposes reducing the radar transmit power to an extremely low level equivalent, for example, to a transmit OFF power level as defined in a wireless communication, such as the Fifth Generation (5G) standard developed by the Third Generation Partnership Project (3GPP), or to a spurious emission level set by authorities such as the Federal Communications Commission (FCC). The probability of interference with communication signals due to radar transmissions at such low transmit power levels or spectral densities is very low, and the radar can therefore be allowed to transmit at any time without coordination with the network. The low power radar signals can, on the other hand, be easily disturbed. Agardh notes that transmission of wireless communication signals may be inhibited in the device while it performs radar probing.

### SUMMARY

The present disclosure relates to wireless communication devices that use the same radio frequency (RF) transceiver for transmitting and receiving both communication signals and radar signals. The wireless device is configured to transmit radar signals at extremely low spectral density so that the receiver can be operated at the same time without saturating. Thus, full duplex operation is possible without the need for RF isolation. To achieve sufficient range, beamforming is used together with a very long correlation time for detection of the radar signal, in which case the receiver can resolve backscattered or reflected radar signals far below the noise floor, while the bandwidth of the transmitted radar signal can be very high. The wide bandwidth enables the wireless device to maintain a low power spectral density while increasing output power, and also increase the depth resolution. The extremely low power spectral density even in the transmission beam direction makes the probability that communication will be disturbed very low. The high bandwidth calls for digital filters for both transmitted and received signals to equalize the radar frequency response characteristics of the radio unit.

A first aspect of the disclosure comprises a front-end circuit for below noise radar in a wireless communication device. In one embodiment, the front-end circuit comprises a transmit signal path connecting a radio frequency (RF) transmitter to a transmit antenna, a power amplifier in the transmit signal path configured to amplify communication signals output by the RF transmitter during communication signal transmission, and a radar amplifier configured to amplify radar signals output by the RF transmitter during radar signal transmission. An input of the radar amplifier is connected to the RF transmitter. An output of the radar amplifier is connected to the antenna through an impedance that reduces an amplitude of the radar signal to a predetermined level.

A second aspect of the disclosure comprises a method implemented by a front-end circuit operable in a communication mode and a radar mode. The method comprises, in the communication mode, coupling communication signals output by a RF transmitter to a transmit antenna through a transmit signal path including a power amplifier. The method further comprises, in a radar mode, coupling radar signals output by the RF transmitter to the transmit antenna through a radar amplifier having an input connected to the RF transmitter and an output connected to the transmit antenna through an impedance. The impedance is configured to reduce an amplitude of the radar signal to a predetermined level.

A third aspect of the disclosure comprises a wireless communication device with radar capability. In one embodiment, the wireless communication device comprises a front-end circuit configured for below noise, full-duplex radar, and processing circuitry configured to detect a reflected radar signal in the presence of interference from a concurrent radar signal transmission.

A fourth aspect of the disclosure comprises a method implemented by a wireless communication device with radar capability. The method comprises receiving, during radar signal transmission, a reflected radar signal with a front-end circuit configured for below noise, full-duplex radar. The method further comprises detecting the reflected radar signal in the presence of interference due to the radar signal transmission.

A fifth aspect of the disclosure comprises s a computer program for a wireless communication device for detecting reflected radar signals. The computer program comprises executable instructions that, when executed by processing circuitry in the wireless communication device, causes it to perform the method according to the fourth aspect.

A sixth aspect of the disclosure comprises a carrier containing a computer program according to the fifth aspect. The carrier is one of an electronic signal, optical signal, radio signal, or a non-transitory computer readable storage medium.

### BRIEF DESCRIPTION OF THE DRAWINGS

FIG. 1 illustrates the main functional components of a wireless communication device.

FIG. 2 illustrates a first embodiment of a radio unit for a wireless communication device.

FIG. 3 illustrates a second embodiment of a radio unit for a wireless communication device.

FIG. 4 illustrates a first implementation of a radar detector for detecting reflections of the transmitted radar signal from remote objects.

FIGS. 5A and 5B illustrate a second implementation of a radar detector for detecting reflections of the transmitted radar signal from remote objects.

FIG. 6 illustrates a third implementation of a radar detector for detecting reflections of the transmitted radar signal from remote objects.

FIG. 7 illustrates a method implemented by a wireless device 10 of transmitting low power spectral density radar signals using the same transmitter as used for wireless communications.

FIG. 8 illustrates a method implemented by a wireless device of receiving and detecting low power spectral density radar signals.

FIG. 9A illustrates an exemplary wireless communication network including one or more wireless devices with radar capability.

FIG. 9B illustrates a user equipment (UE) with radar capability according to an embodiment.

FIG. 9C illustrates a base station with radar capability according to an embodiment.

FIG. 10A illustrates a first exemplary radar amplifier with a self-biased CMOS inverter.

FIG. 10B illustrates second exemplary radar amplifier also with a self-biased CMOS inverter.

FIG. 10C illustrates a radar amplifier 82 configured as a tuned amplifier.

### DETAILED DESCRIPTION

The present disclosure relates to a wireless communication device 10 that uses the same radio frequency (RF) transceiver for transmitting and receiving both communication signals and radar signals. The techniques for implementing radar in the wireless communication device 10 is explained in the context of a wireless communication device configured to operate according to the 5th Generation (5G) standard developed by the Third Generation Partnership Project (3GPP). More generally, the wireless communication device 10 could operate according to any standard now known or later developed including without limitation Wideband Code Division Multiple Access (WCDMA), Long Term Evolution (LTE), Worldwide Interoperability for Microwave Access (WiMAX), Wireless Fidelity (WiFi), or 6th Generation (6G).

Frequency resources available for wireless communications are limited and very expensive. Introducing radar operation in a given frequency band will typically lower the quality and/or limit the resources available for communications. Coordination of frequency resources is also needed to avoid collision between communication and radar. A radar solution using minimal resources and requiring little or no coordination with the network would therefore be very attractive.

Most radar operations are based on mono-static radar, where the same device both receives and transmits. Operating a high-powered transmitter and a sensitive receiver at the same frequency in the same RF unit is challenging but can be solved by introducing physical isolation between antennas. This solution requires shielding metal and/or significant distances, which are expensive and impractical in a handheld unit. Furthermore, when using some antennas for transmission and others for reception, beamforming gain is reduced.

The separation between transmit and receive can also be realized in the time domain. In this case, all antennas transmit and all receive, but not at the same time. This approach requires fast antenna switches so that the switches can change their state during the short time period between the end of radar transmission and the return of the first reflection. This approach requires trade-offs in antenna switch design and very short radar signal duration that limits the sensing range.

Full-duplex solutions allowing transmission and reception at the same time from the same set of antennas exist. At high transmit power, however, there are many challenges in cancelling the strong transmit signal and its effect in the receiver. Cancellation must be performed in multiple domains: RF as well as digital baseband. The RF cancellation becomes costly and complicated in an array system due to multiple antenna channels. A full duplex system capable of radar operation without the need for RF cancellation would thus be highly attractive.

To alleviate some of these problems, embodiments of the present disclosure reduce the radar transmit power to an extremely low level equivalent, for example, to a transmit OFF power level as defined by the applicable wireless communication standard (e.g., 5G standard), or to a spurious emission level set by authorities such as the FCC. The power level may depend on channel bandwidth. As one example, the maximum transmit power level for radar signals could be set to −50 dBm transmit power. The threshold may also be given as power spectral density rather than a power level. The probability of interference with communication signals due to radar transmissions at such low power levels or spectral densities is very low, and the radar can therefore be allowed to transmit at any time without coordination with the network. The low power radar signals can, on the other hand, be easily disturbed.

Low power radar reduces the required isolation and hence simplifies the design, and lends itself well to full duplex operation, i.e., to receive and transmit radar signals simultaneously. But the very low transmit powers required to realize these advantages limit the target range for radar detection to a few tens of meters and the velocities of the target to a few meters per second. Example applications for such low power radar include gesture tracking, indoor positioning, and drone altitude detection.

Detection of low power radar signals requires long observation times to obtain sufficient SNR. The correlation gain becomes high when correlating for a long time, and this approach works fine for slow moving targets but is not well-suited for higher velocities. Additional gains may be obtained using repetition in time and/or frequency to increase the SNR of the reflected radar signals. This approach may require hundreds or thousands of repetitions to obtain meaningful gains. For moving objects, the repetitions cannot be distributed over too long a time and there may be limits on available bandwidths for large numbers of repetitions in the frequency domain.

Applications of radar have changed in the past from being used in a dedicated and deliberate way to estimate precipitation, track a target in a military application, or capture data about the surroundings of a vehicle that is about to make a turn in an intersection, etc. But for applications that need to work over long durations and without any particular triggering events to indicate when radar is needed, a conventional radar operated in an always-on mode will use a lot of power and cause interference even if not used.

One aspect of the disclosure comprises techniques for implementing radar functionality in wireless communication devices 10. The wireless communication device 10 is configured to transmit radar signals at extremely low spectral density so that the receiver can be operated at the same time without saturating. The radar signal is amplified by a small radar amplifier operating while the regular power amplifier is turned off. The radar amplifier couples to the antenna signal through a large impedance to output a very low transmit power. Thus, full duplex operation is possible without the need for RF isolation.

The extremely low output power makes it safe to operate without coordination with the network, as causing a disturbance to communication would require an extreme proximity, i.e. close contact. If, however, a strong signal is detected, after the radar transmission signal has been subtracted, the radar operation can be interrupted or aborted to avoid even this small risk of causing interference.

The high bandwidth needed to reduce the spectral density may require equalization to achieve full radar performance. To achieve equalization, digital filters can be used in both receive signal path and transmit signal path.

To achieve sufficient range, beamforming is used together with a very long correlation time for detection of the radar signal, in which case the receiver can resolve backscattered or reflected radar signals far below the noise floor, while the bandwidth of the transmitted radar signal can be very high. The wide bandwidth enables the wireless device to maintain a low power spectral density while increasing output power, and also increase the depth resolution. The extremely low power spectral density even in the transmission beam direction makes the probability that communication will be disturbed very low. The high bandwidth calls for digital filters for both transmitted and received signals to equalize the radar frequency response characteristics of the radio unit.

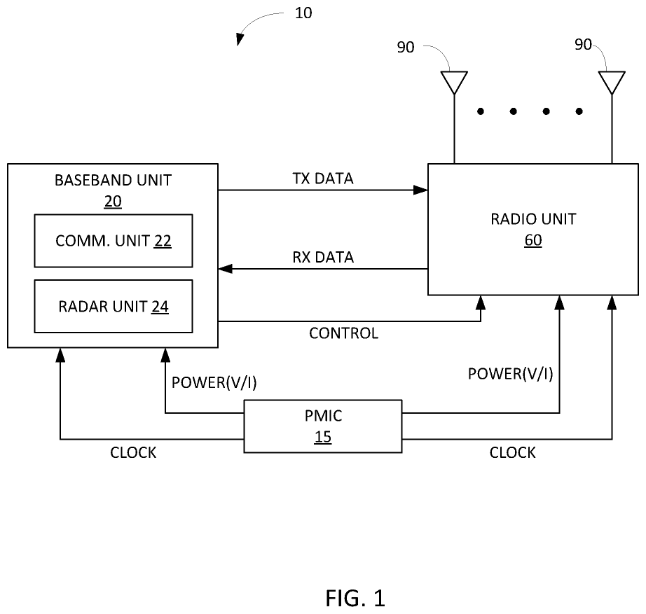

To demonstrate the feasibility of the concept, a numerical example will be provided. Assume a wireless communication device 10 with 100 antenna elements per panel, operating at 100 GHz center frequency with a 10 GHz bandwidth and a 14 dB total noise figure of the receiver. The receiver input noise floor in the 10 GHz bandwidth is equal to −60 dBm at each antenna. Further assume that the radar transmitter can provide-40 dBm per antenna, i.e., 20 dB above the receiver noise. Taking into account losses in the antenna switch (as shown in FIG. 1) of 3 dB, the radar transmitter will have to provide 3 dB more power for the signal on top of the 20 dB above the noise floor, i.e., −37 dBm per antenna. We assume that the receiver can handle a signal 23 dB above the noise floor without significant compression. It is then possible to subtract the transmit signal in the digital domain in the receiver.

The antenna gain is assumed to be 3 dB+10 log (100)=23 dB for both transmit and receive, where 100 is the number of antenna elements in the panel. In this case, the EIRP becomes −40 dBm+20 dB+23 dB=3 dBm, where the 20 dB is due to the 100 transmitters providing output power. The total radiated power (TRP) is −20 dBm. Assuming an integration time of up to 3 ms, we get a received radar signal noise of:

$$- 1 \; 74 dBm + NF - 10 log ( integration time ) = - 174 + 14 + 25 = - 1 \; 35 dBm$$

The power of a reflected radar signal for an object at 10 m distance with a radar cross section of 0.01 m² can be calculated according to:

$${P}_{received} = {P}_{T X} + {G}_{T X a n t} + {G}_{R X a n t} + 10 log [ \frac{{λ}^{2} \cdot σ}{{( 4 π )}^{3} \cdot {R}^{4}} ] ]$$

where P_{TX} is the transmit power, G_{TXant}, is the transmitter antenna gain, G_{RXant}, is the receiver antenna gain, λ is the electromagnetic wavelength in air at the radar center frequency, σ is the radar cross section of the target to be detected, and R is the distance between the radar and the target. With these assumptions, the received power of the radar signal is:

$${P}_{received} = - 20 dBm + 23 dB + 23 dB + 10 log ( 0.00 {3}^{2} \cdot 0.01 / ( {( 4 - 3.14 )}^{3} \cdot {10}^{4} ) ) = - 117 dBm = > SNR = - 117 - ( - 135 ) = 18 dB$$

It would thus be possible to detect an object with a radar cross section of 0.01 m² at 10 m distance with a correlation time of 3 ms, i.e., it would be possible to operate indoors with good possibility to detect also small objects with a high SNR.

FIG. 1 illustrates the basic architecture of a wireless communication device 10 in which the radar functionality is to be implemented. It is noted that the same reference numbers are used throughout the drawings to indicate similar elements or features. The wireless communication device 10 comprises a power management integrated circuit 15, baseband unit (BBU) 20, and radio unit (RU) 60 coupled to one or more antennas 90. The PMIC 15 provides power and clock signals to the BBU 20 and RU 60. The BBU 20 comprises the digital part of the wireless communication device 10 and the RU 60 comprises the radio part. The BBU 20 performs digital signal processing and controls the operation of the wireless communication device 10. The BBU 20 outputs controls signals to the RU 60 during operation. In embodiments of the present disclosure, the BBU 20 includes a communication unit 22 which is configured to transmit and receive communication signals and a radar unit 24 configured to transmit and receive radar signals. The RU 60 comprises RF circuitry for transmitting and receiving both communication signals and radar signals. The RU 90 couples to one or more antennas or antenna elements 90.

As used herein, the term “communication signals” refers to data signals and control signals transmitted and received by the wireless communication device 10 as part of normal operation according to applicable standards but does not include radar signals. In the context of 5G, the term “communication signals” contemplates all signals transmitted and received by the 5G wireless communication device 10. Communication signals may comprise, for example, data signals transmitted by the wireless communication device 10 on the Physical Downlink Control Channel (PDCCH), Physical Downlink Shared Channel (PDSCH) and Physical Broadcast Channel (PBCH), and all signals received by the wireless communication device 10 on the Physical Uplink Control Channel (PUCCH), Physical Uplink Shared Channel (PUSCH).

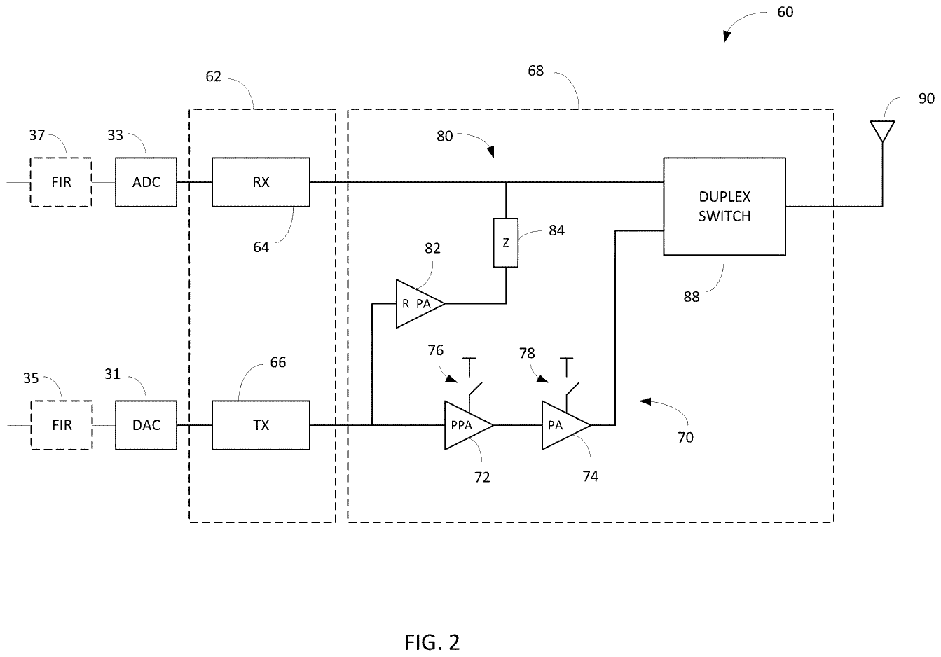

FIG. 2 illustrates a first embodiment of a RU 60 for a wireless communication device 10. The RU 60 comprises a digital-to-analog converter (DAC) 31, analog-to-digital converter (ADC) 33, RF transceiver 62 and a front-end circuit 68. Some embodiments may further include transmit and receive filters 35, 37 to compensate for the frequency response of the RU 60 as hereinafter described. The DAC 31 converts transmit signals output by the BBU 20 to the analog domain. The ADC 33 converts analog signals to the digital domain for input to the BBU 20. The RF transceiver 62 comprises a RF receiver 64 and RF transmitter 66 configured to operate according to applicable standards. The front-end circuit 68 connects the RF transceiver 62 to an antenna array comprising one or more antennas or antenna elements 90. FIG. 2 illustrates the connection to one shared antenna or antenna element 90 with the understanding that each antenna or antenna element 90 has a similar arrangement. The shared antenna or antenna element 90 is used for both transmission and reception.

In this embodiment, the front-end circuit 68 is configured for time division duplex (TDD) operation. The front-end circuit 68 comprises a transmit signal path 70 and a receive signal path 80 connecting the RF transmitter 66 and RF receiver 64 respectively to the antenna or antenna element 90 via a duplex switch 88. The duplex switch 88 is movable between a receive position to connect the antenna or antenna element 90 to the RF receiver 64 and a transmit position to connect the antenna or antenna element 90 to the RF transmitter 66. The transmit signal path 70 includes a pre-power amplifier (PPA) 72 and power amplifier (PA) 74 for amplifying communication signals output by the RF transmitter 66 in a communication mode. Switches 76 and 78 allow the BBU 20 to disable the PPA 72 and PA 74 during radar signal transmission. A radar amplifier 82 is connected between the transmit signal path 70 and receive signal path 80. The radar amplifier 82 takes the input from the transmit signal chain, e.g., before the PPA 72. The PPA 72 and PA 74 are turned off during radar operation, and the duplex switch 88 is placed in the receive position, connecting the receive signal path 80 to the antenna or antenna element 90. The small radar amplifier 82 injects the transmitted radar signal into the receive signal path 80, which is connected to the antenna 90, through a large impedance (Z) 84. The large impedance (Z) 84 provides a large voltage division between Z and the RF receiver input impedance, dividing the voltage from the small radar amplifier 82 at the RF receiver input, so that a small signal only is injected to avoid saturating the RF receiver 64. The connection of the radar signal to the receive port of the duplex switch 88 protects the radar amplifier from large voltage levels generated when communication signals are transmitted.

In a communication signal transmission mode, the PPA 72 and PA 74 are enabled and the duplex switch 88 is in the transmit position. The RF transceiver 66 outputs a communication signal, which is amplified by the PPA 72 and PA 74 and radiated by the antenna or antenna element 90. The radar amplifier 82 can be disabled in the communication signal transmit mode. In a communication signal receive mode, the PPA 72 and PA 74 are disabled and the duplex switch 88 is in a receive position so that the received signal is coupled to the RF receiver input. The radar amplifier 82 can be disabled in the communication signal receive mode if no radar signal is being transited. In a radar transmission mode, the PPA 72 and PA 74 are disabled and the duplex switch 88 is in the receive position. The RF transceiver 66 outputs a radar signal, which is amplified by the radar amplifier 82 and radiated by the antenna or antenna element 90. The BBU 20 sends a control signal to the RU 60 to enable and disable the PPA 72 and PA 74. The impedance (Z) 84 reduces the radar signal at the input of the receiver. In one embodiment, the impedance 84 is between about 500 Ohms and 5000 Ohms. In some embodiments, the impedance (Z) 84 is configured to reduce a transmitted radar signal below a signal level threshold at the RF receiver (64) input during radar signal transmission so as to enable simultaneous reception of a communication signal by the RF receiver 64. In some embodiments, the signal level threshold may be below a noise threshold at the RF receiver input. In other embodiments, the impedance (Z) 84 is configured to reduce a transmitted radar signal below a compression threshold at the RF receiver input during radar signal transmission to reduce compression at the RF receiver 64.

At high frequencies, separate antennas 90 may be used for receiving and transmitting to avoid using antenna switches which have high losses. One straight forward solution would then be to back off the transmit power in the PA 72 and PPA 74 and reuse the RF transmitter 66 for ultra-low power radar transmission. This approach would require an extended power control range in the RF transmitter 66, which complicates its design, and such operation is likely be very inefficient. Further, the output noise must be low enough so that radar operation is not affected.

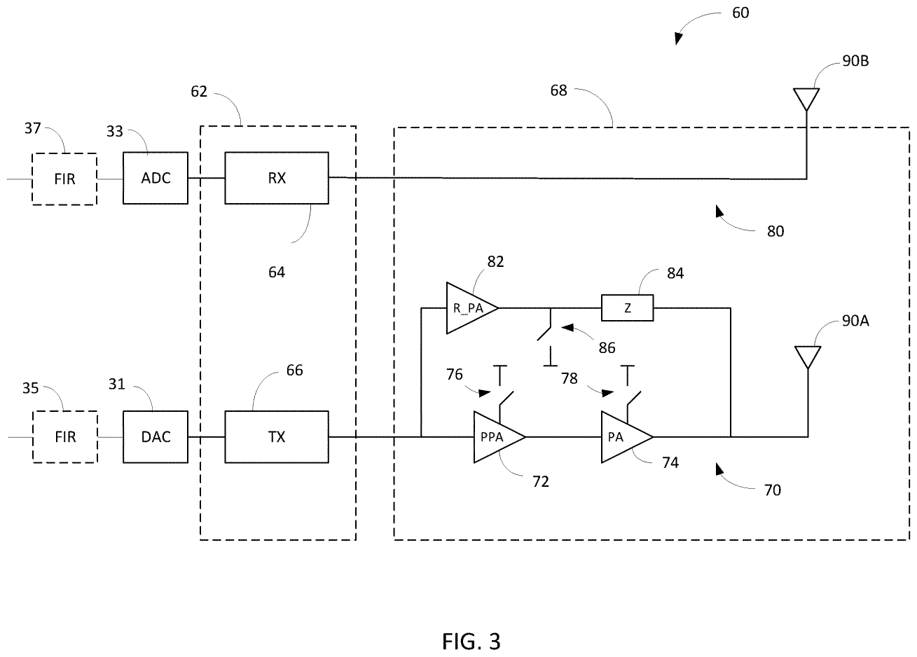

FIG. 3 illustrates a second embodiment of the front-end 68 for the scenario where separate antennas 90A and 90B are used for transmitting and receiving respectively. Similar reference numbers are used to indicate similar components. In this embodiment, the radar amplifier 82 is connected to the same antenna input as the PA 74 and delivers the radar output through the impedance (Z) 84. The PA 72 and PPA 74 could be turned off during radar transmission. However, the connection of the radar amplifier 82 to the same output as the PA 74 requires some consideration. The small radar amplifier 82 is connected to the output of the PA 74, which can produce large voltage amplitudes. By connecting the small radar amplifier 82 through the large impedance 84, it can more easily be protected from damage due to high voltages using a switch 86 connected between the output of the radar amplifier 82 and the impedance 84. The switch 86 is configured to shunt the small radar amplifier output to ground when the PA 74 is active, and due to the high impedance connected between the output of the small radar amplifier 82 and the PA output, the signal current that the switch 86 needs to handle will be very limited. The switch 86 can be small and will thus cause minor losses in the output of the small radar amplifier 82. The small signal current will also ensure a minimal effect on the PA characteristics and performance. In some embodiments, the radar amplifier 82 may be disable when communication signals are being transmitted.

The −37 dBm of transmit power in the example above corresponds to just 4.5 mV voltage amplitude in a 50Ω antenna. If the radar amplifier provides 100 mV amplitude, a 1 kΩ resistor in series with the radar amplifier provides the required impedance Z to perform the voltage division. The resistor will have some internal parasitic capacitance, which will affect the predictability of the voltage transfer. Using a larger resistor and larger division ratio may thus not be practical. Another option is to use a capacitor to perform the voltage division. A capacitor with 1 kΩ impedance at 100 GHz would have the value 1.6 fF, which is easily realized.

There are a number of options to realize the radar amplifier 82. One approach uses a radar amplifier 82 with a tuned output, as integrated inductors have very small physical size at 100 GHz. Another approach uses a self-biased CMOS inverter, naturally loaded by a capacitive load, and coupled to the antenna 90, 90A with a capacitor. The load capacitor and coupling capacitor would then form a frequency independent current division network, such that a fixed fraction of the current output by the transconductances would go to the load. The efficiency would, however, be better with a tuned amplifier. The tuning could then also be designed to include the coupling capacitor, making it more efficient than using a coupling resistor.

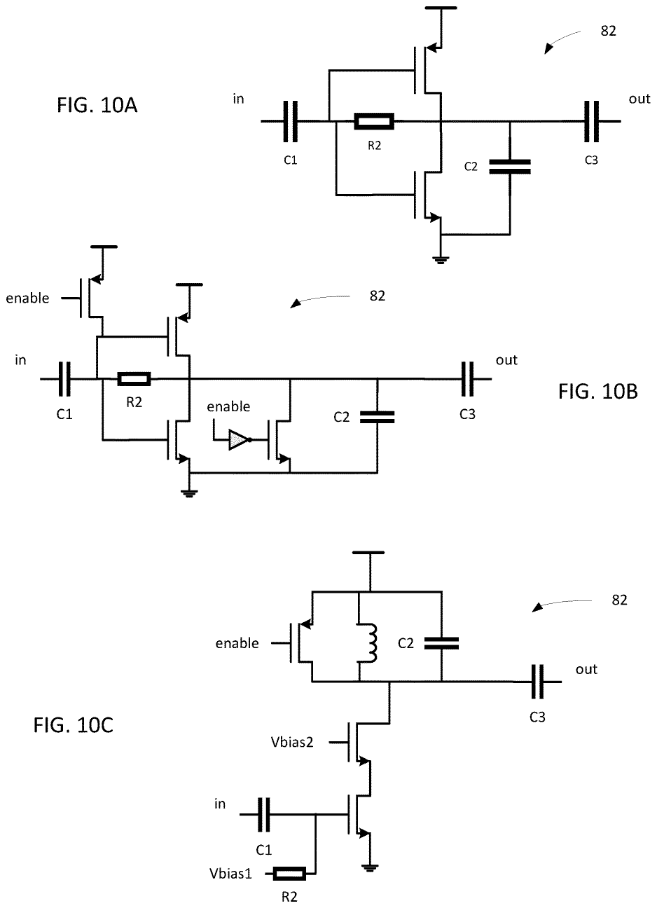

FIG. 10A illustrates a first exemplary radar amplifier 82 with a self-biased CMOS inverter. The inverter consists of the two transistors, one NMOS and one PMOS. It is self-biased by resistor R2, making the inverter input bias voltage equal to its output bias voltage. To enable this the input is AC-coupled by C1, so that the DC input voltage does not affect the inverter input bias voltage. At the output, there is a load capacitor C2, which at least partly consists of parasitic capacitances. The output is coupled to the antenna 90 (which is connected to out terminal) by coupling capacitor C3. The coupling capacitor also blocks DC at the output from affecting the bias of the inverter, similar to C1 at the input. The load capacitor C2 and coupling capacitor C3 form a frequency independent current division network, such that a fixed fraction of the current output by the transconductance of the transistors go to the antenna 90.

FIG. 10B illustrates a second exemplary radar amplifier also with a self-biased CMOS inverter. In addition to the features shown in FIG. 10A, this embodiment contains protection from high voltages due to the communication PA 74. This protection is needed in the case there are separate transit and receive antennas 90a and 90B, and the radar amplifier 82 is connected to the transmit antenna 90A. In this case, the radar amplifier 82 is not protected by a duplex switch 88 during communication signal transmission. When the enable signal is low, the radar amplifier 82 is protected. The NMOS transistor at the output then conducts, since its gate voltage is made high by the inverter connected to its gate, pulling the output to ground. The inverter input is pulled high by the PMOS transistor there, with the gate connected to the enable signal. The NMOS of the inverter will then help pulling the output node towards ground. The effective resistance of the inverter output will be the parallel on-resistance of the two NMOS transistors. The resistance R2 will have close to the full supply voltage over it, by as its resistance is high the power consumption will still be low. The signal voltage at the inverter output will be the antenna voltage, reduced by the voltage division between C3 and the parallel on-resistance on the NMOS devices, and as C3 has a high impedance at the carrier frequency the signal voltage will be low, preventing damage to the transistors. When the enable signal is high, the additional transistors are off, and the amplifier works as the schematic at the top.

FIG. 10C illustrates a radar amplifier 82 configured as a tuned amplifier, where the inductor is made to resonate at the carrier frequency together with its surrounding capacitance. In this embodiment, the radar amplifier 82 comprises an NMOS cascode amplifier, where the input signal is AC connected to the gate of the bottom transistor. The gate bias voltage is set through a large resistor R2. The stacked on top transistor is a cascode device, which can be used to make the circuit more robust, improving stability and reverse-isolation. C2 is a tuning capacitor, at least partly consisting of parasitic capacitance, together with the inductor setting the center frequency of the amplifier, which is the resonance frequency of the inductor and its surrounding capacitance. C3 will also have some influence on that capacitance, but being much smaller than C2, its influence will be much less. C3 couples the signal to the antenna, being a small capacitor ensures delivering a small current. Using a capacitor for coupling also isolates the antenna from the output bias voltage of the radar amplifier 82, which is equal to the supply voltage. The protection of the radar amplifier 82, if needed, is handled by the PMOS transistor. When the enable signal is low, a low resistance is provided between the output and the supply voltage, i.e., to signal ground. Voltage division between C3 and the PMOS on-resistance then protects the transistors. When enable is high, the PMOS is off, and the radar amplifier 82 can operate and provide an output signal. The parasitics of the PMOS are included in the capacitance when designing the inductance value, so the amplifier center frequency will be correct when including the protection circuitry.

Depending on the antenna signal, the amplifiers can be single-ended or differential. In some embodiments, the radar amplifier 82 may be eliminated and the large impedance Z (or pair of impedances if differential) can be connected directly to a suitable node or node pair in the transmit signal path. The idea of reusing the communication receiver and transmitter for radar may be more problematic if the RF receiver 64 and RF transmitter 66 share parts, like phase shifters or combination networks. In this case, it becomes difficult to operate the RF receiver 64 and RF transmitter 66 simultaneously. Such transceiver architectures should thus be carefully considered when reusing communication modem parts for full duplex radar.

In some embodiments of the present disclosure, beamforming along with this full-duplex radar can be used to direct the emitted radar signals and increase the sensing range. Beamforming also focuses the receiver towards the sensing direction, achieves a higher quality reception of reflected signals, and identifies the direction to the object.

The radar signal does not pose an interference problem for received communications signals in normal scenarios, due to its low power spectral density. However, the full-duplex operation may pose certain challenges for received radar signal reception because the reflected radar signal is typically attenuated by multiple 10s of dBs and requires considerable processing gain to sufficiently increase the detection SNR, even when the low noise amplifier (LNA) is not saturated.

In one embodiment, an antenna cancellation scheme may be used with separate active antennas for transmission and one antenna for reception at a node. The phase difference between transmit antennas is adjusted depending on their respective distances to the receive antenna so that the resulting transmitted signal superimposes destructively at the receive antenna. However, one of the targeted advantages of this invention is to utilize all antennas for both transmit and receive.

In another embodiment, a digital canceller estimates the magnitude, phase shift and delay of the clean transmitted radar signal as seen at the RF receiver input, where the calibration is updated periodically to track the main crosstalk channel. For example, the calibration may be obtained by the same correlation operation used to detect radar reflections, and leakage parameters can be extracted from the correlation results with near-zero delays. The transmitted signal can be modified according to the estimated parameters and subtracted from the received signal.

Depending on the leakage parameter estimation quality, 20-40 dB of transmit leakage reduction can be obtained by subtraction of the estimated transmit leakage in the baseband. The correlation length for radar signal detection may be selected further based on the remaining transmit signal leakage that needs to be suppressed, combined with the estimated signal attenuation at the targeted sensing distance.

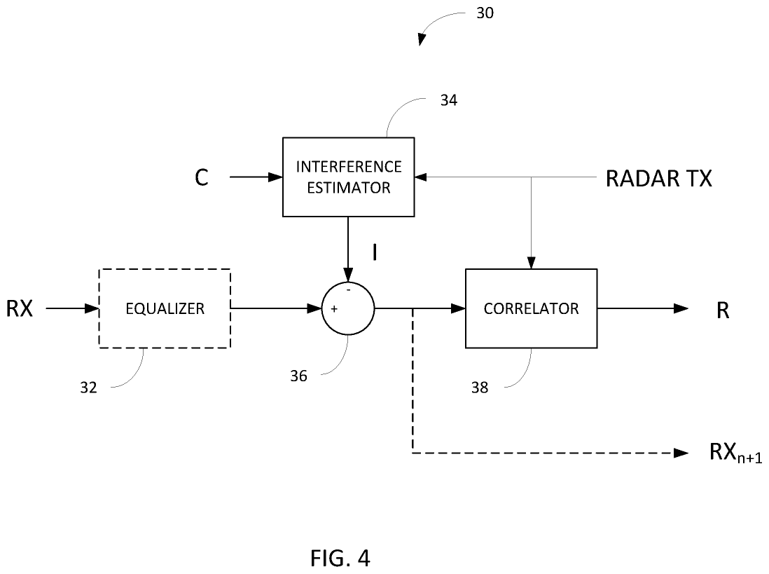

FIG. 4 illustrates a first implementation of a baseband radar detector 30 for detecting reflections of the transmitted radar signal from remote objects, which is part of the radar unit 24. In this embodiment, the radar detector 30 comprises an equalizer 32, interference estimator 34, subtraction circuit 36, and correlator 38. The equalizer 32 is an optional component to compensate for the frequency response of the RF front end 68 as hereinafter described. In this example, it is assumed that the radar reflection is received without interference from a communication signal. The received radar signal for the reflection is input to the subtraction circuit 36 following equalization if an equalizer is present 32. A clean copy of the transmitted radar signal is input to the interference estimator 34 along with an estimate of the crosstalk channel C between the output of the RF transmitter 66 to the input of the RF receiver 64. The interference estimator 34 generates an estimate/of the interference attributable to the transmit signal leakage based on the clean radar transmit signals and the channel estimate C, and outputs the interference estimate/to the subtraction circuit 36. The subtraction circuit 36 subtracts the estimated interference from the received radar reflection to at least partially cancel the interference attributable to transmit signal leakage and outputs the reduced interference signal to the correlator 38. The correlator 38 receives the transmitted radar signal as an input and correlates the reduced interference signal with the transmitted radar signal to detect the reflected radar signal R. The correlator output R can be compared to a threshold to detect presence of a reflection.

In an alternative embodiment, leakage removal for received echo detection can be omitted if the correlation/accumulation provides a sufficient processing gain (e.g., the 20-40 dB of reflection attenuation+3-6 dB for reliable detection) and the baseband processing provides sufficient computational resolution (bit widths). The processing gain example above assumes that the radar signal has a pseudo-random structure. If a special signal radar design is used that provides controlled auto-correlation properties, the required processing gain may be significantly lower. (However, such a signal design may be optimized for certain echo delays, not for arbitrary delays.)

As an additional improvement, the baseband interference cancellation circuitry may further subtract stronger echoes from the received signal to facilitate detection of further, weaker reflections. The signal to subtract may be estimated by deconvolution and filtering of the correlation response for the delay range of the echo of interest and convolving the extracted channel response with the transmitted signal.

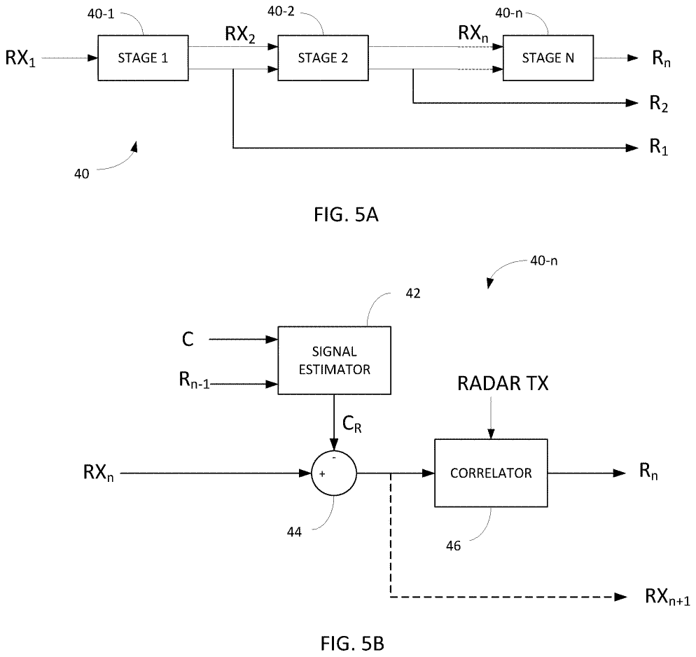

FIGS. 5A and 5B illustrate a second implementation of a baseband radar detector 40 configured to detect multiple reflections using successive interference cancellation (SIC). FIG. 5A illustrates a detector 40 with N stages denoted as 40-1, 40-2, . . . 40-n. The received signal RXₙ in this embodiment is a combined signal containing multiple reflections of the radar signal. Each stage detects and outputs one radar reflection Rₙ. Each stage, except for the last stage, outputs a combined signal RXₙ₊₁ with the multiple reflections to the next stage. Each stage following the first stage 40-1 cancels the signal component attributable to the detected reflection Rₙ₋₁ output by the previous stage to successively remove the reflections from the combined signal.

The first stage 40-1 may be the same as the detector shown in FIG. 4, except that an additional output is provided to output the combined signal, which is shown by dotted lines in FIG. 4. The combined signal output to the next stage is denoted RXₙ₊₁, which is the same as the combined signal at the input to the first stage with interference attributable to the transmit signal leakage removed. That is, no signal reflections are cancelled in the first stage 40-1.

FIG. 5B illustrates an exemplary stage n following the first stage. Stage n comprises a signal estimator 42, subtraction circuit 44, and correlator 46. Stage n receives as input a combined signal RXₙ, and the detected reflection Rₙ₋₁ output from the previous stage. The combined signal RXₙ is the combined signal output from the previous stage (RXₙ₊₁ from previous stage) after interference reduction or signal cancellation. The signal estimator 42 receives as inputs the radar reflection detected by the previous stage and an estimate of the crosstalk channel C between the output of the RF transmitter 66 to the input of the RF receiver 64. The signal estimator 42 generates an estimate of the radar reflection component C_{R} in the combined signal RXₙ received as input, which is a convolution of the detected reflection Rₙ₋₁ from the previous stage and the estimated channel C. The signal estimator 42 outputs the component estimate C_{R} corresponding to the detected radar reflection to the subtraction circuit 44. The subtraction circuit 44 subtracts the estimated signal component C_{R} corresponding to the detected radar reflection to at least partially cancel the radar reflection from the combined signal RXₙ. The correlator 46 receives the transmitted radar signal as an input and correlates the combined signal RXₙ₊₁ output to the next stage with the transmitted radar signal to detect the reflected radar signal Rₙ in the combined signal. The output for RXₙ₊₁ is not needed in the last stage.

To address radar signal leakage-induced interference to communications, the relative radar-induced interference level can be estimated based on, for example, the communication signal Reference Signal Received Quality (RSRQ) or Signal to Interference plus Noise Ratio (SINR). If that measurement is above a threshold, the communication signal can be received. Radar transmit leakage signal subtraction (interference cancellation) may also be applied as described above.

During radar detection, a received communication signal may also interfere with the received radar signal. In one embodiment, the power of received communication signal to be suppressed by the radar receiver is added as a criterion for determining the required radar processing gain. Any power measurement can be used, such as the Reference Signal Received Power (RSRP)

FIG. 6 illustrates a third implementation of a baseband radar detector 50 configured to adjust the correlation gain of the correlator 54 depending on the measurement of signal strength of a communication signal. In this embodiment, the radar detector 50 comprises an optional equalizer 51, an interference estimator 52, subtraction circuit 53, correlator 54, detector 56, and gain adjustment circuit 58. A combined signal RX including the communication signal and radar reflection is input to the equalizer 51 (or subtraction unit 53) and detector 56. The equalizer 51, when present, compensates for the frequency response of the RF front end 68 previously described. The combined signal RX is input to the subtraction node 53 following equalization if an equalizer 51 is used. A clean copy of the transmitted radar signal is input to the interference estimator 52 along with an estimate of the crosstalk channel C between the output of the RF transmitter 66 to the input of the RF receiver 64. The interference estimator 52 generates an estimate of the interference/attributable to the transmit signal leakage based on the clean radar transmit signal and the channel estimate C, and outputs the interference estimate/to the subtraction circuit 53. The subtraction circuit 53 subtracts the estimated interference/from the combined signal to at least partially cancel the interference due to transmit signal leakage and outputs the reduced interference signal to the correlator 54.

The detector 56 receives the combined signal RX and estimates the signal strength of the communication signal component. The estimate of the signal strength, such as the RSRP or RSRQ, is output to the gain adjustment circuit 58. The gain adjustment circuit determines the correlation gain G need to detect the radar reflection in the combined signal based on the signal strength measurement from the detector 56. The correlator 54 receives the transmitted radar signal as an input and correlates the reduced interference combined signal with the transmitted radar signal to detect the reflected radar signal

To take full advantage of the resolution offered by the high bandwidth, compensation for analog transfer functions may be needed. Otherwise, there is a risk that some radar accuracy is lost due to limited bandwidth in the transmitter and receiver paths as well as the antennas 90, antennas switch 88, etc.

The compensation can be performed by the digital baseband, for both transmit and receive. Digital filters, such as a Finite Impulse Response (FIR) filter, can be used to increase the level of higher baseband frequencies compared to lower ones. If a filter 35 is placed prior to the DAC 31 in the RU 60, it can compensate for subsequent drop at higher modulation frequencies due to analog bandwidth limitations. Similarly, a filter 37 placed after the ADC 33 in the receive path can lift high frequency modulation components that have been attenuated, but then also noise is raised at those frequencies. Using the filter 35 for transmission does not experience the same problem, but on the other hand, the transmit spectral density may become too high if compensating also for receive bandwidth. A good compromise is to use two filters 35, 37, one for transmission to compensate for the transmit bandwidth so that the transmitted signal has close to flat spectral density, and one for receiving to compensate for its limited bandwidth.

In case the RF channel is located off-center frequency of the RF components, such as antennas, switches, and amplifiers, the baseband frequency response will be different for positive and negative baseband frequencies. In that case a complex baseband digital filter can be used.

There are different options for determining the coefficients of the filters 35, 37. One is to have the filters 35, 37 set in the factory after suitable measurements of selected samples of all devices. Another is to calibrate the device by reflecting a radar signal back to the receiver and performing a calibration. The device can then transmit a signal, receive the reflection, and adjust the filters 35, 37 until the frequency response is as expected, typically flat. The transmit filter 35 could be kept equal to the receive filter 37, or other partitioning of the compensation could be used. Another possibility is that two channels are connected by a transmission line, instead of two antennas 90, in which case they can be used to characterize the transfer function of all parts involved except the antennas 90.

If incomplete or imperfect frequency compensation is applied, or none, the actual radar signal will differ to some extent from the undistorted reference copy used for receiver correlation. In one embodiment, the residual non-flat frequency response is estimated and applied to the reference sequence before performing correlation and detection.

The full duplex operation described herein enables the use of listen during talk (LDT), further improving the performance. Similar to listen before talk (LBT), the wireless device 10 can abort a radar transmission if it detects a strong received communication signal, after having subtracted its own transmit signal leakage. In this case, there is little benefit in continuing the radar transmission because the radar reception will likely be blocked by the strong communication signal when the echoes return. The wireless device 10 may then instead abort and save some power. Aborting also reduces risk of interfering with nearby devices when it transmits, which could be either immediately if operating with full duplex or with FDD, or later if operating with TDD.

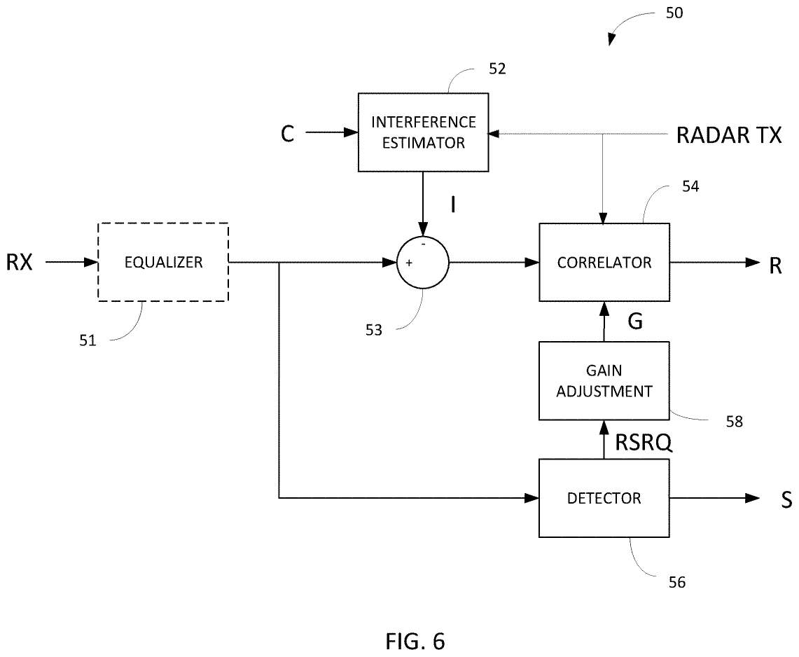

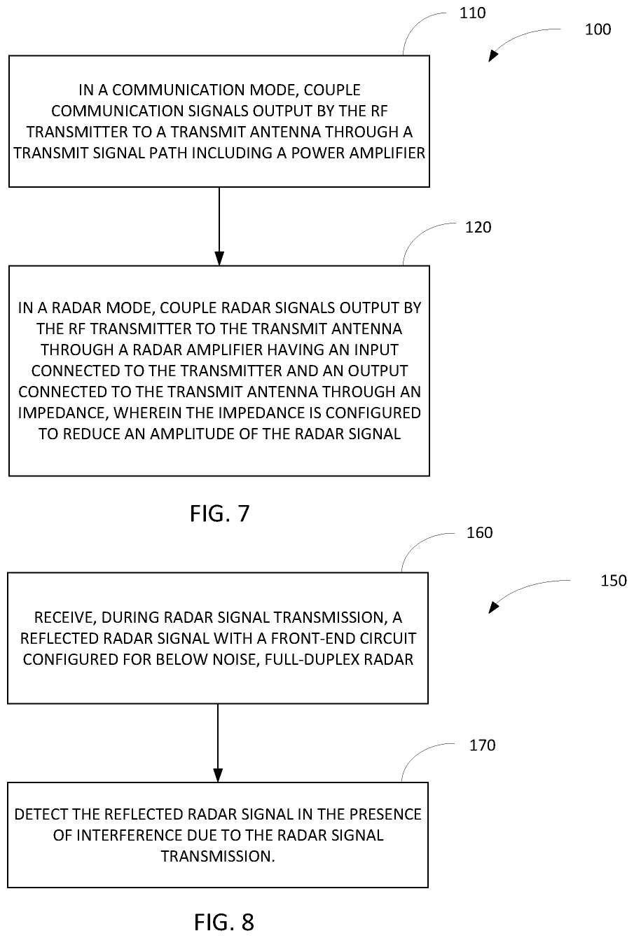

FIG. 7 illustrates a method 100 implemented by a RU 68 in a wireless device 10 configured to transmit low power spectral density radar signals using the same transmitter as used for wireless communications. The wireless device 10 is operable in a communication mode and a radar mode. In a communication mode, the RU 68 couples a communication signal output by a RF transmitter 66 to a transmit antenna 90, 90A through a transmit signal path including a power amplifier 74 (block 110). In a radar mode, the RU 68 couples a radar signal output by the RF transmitter 66 to the transmit antenna 90, 90A through a radar amplifier 82 having an input connected to the RF transmitter 66 and an output connected to the transmit antenna 90, 90A through an impedance 84 (block 120). The impedance 84 is configured to reduce an amplitude of the radar signa.

In some embodiments of the method 100, the input of the radar amplifier 82 is connected to the transmit signal path 70 between the RF transmitter 66 and the power amplifier 74.

In some embodiments of the method 100, the transmit antenna 90, 90A comprises a shared antenna that is shared by the RF transmitter 66 and a RF receiver 64, and wherein the method further comprises coupling a received signal received by the shared antenna 90 through a receive signal path 80 to an input of the RF receiver 64.

In some embodiments of the method 100, the receive signal path and transmit signal path are coupled to the shared antenna by a duplex switch 88, and wherein the method further comprises switching the duplex switch 88 to a first position to connect the transmit path 70 to the shared antenna 90 and switching the duplex switch 88 a second position to connect the receive signal path 80 to the shared antenna 90.

In some embodiments of the method 100, coupling the radar signal output by the RF transmitter to the transmit antenna comprises coupling the radar signal through the impedance to the receive signal path 80 in front of the duplex switch 88.

In some embodiments of the method 100, switching the duplex switch 88 to the second position for radar signal transmission.

In some embodiments, the impedance is in the range from about 500 Ohms to about 5000 Ohms.

In some embodiments of the method 100, reducing a transmitted radar signal comprises reducing the radar signal below a signal level threshold at a RF receiver input during radar signal transmission so as to enable simultaneous reception of a communication signal by the RF receiver 64.

In some embodiments of the method 100, reducing a transmitted radar signal to a predetermined level comprises reducing the radar signal below a compression threshold at a RF receiver input during radar signal transmission to reduce compression at the receiver. In one example, the impedance 84 is selected so that reduction of the reflected radar signal due to compression is less than about 3 dB. In another embodiment, the impedance 84 is selected so that reduction of the reflected radar signal due to compression is less than about 1 dB.

In some embodiments of the method 100, coupling a reflected radar signal received by a separate receive antenna 90, 90B to an input of a receiver via a receive signal path 80.

In some embodiments of the method 100, coupling a radar signal output by the RF transmitter 66 to the transmit antenna 90, 90A comprises coupling the radar signal through the impedance 84 to the transmit signal path 70 following the power amplifier 74.

In some embodiments of the method 100, connecting the receive signal path 80 to signal ground during communication signal transmission.

Some embodiments of the method 100 further comprise reducing a transmitted radar signal below a signal level threshold at an input to the transmit antenna during radar signal transmission so as to enable simultaneous reception of a communication signal.

Some embodiments of the method 100 further comprise receiving a reflected radar signal by the RF receiver simultaneously during radar signal transmission.

Some embodiments of the method 100 further comprise transmitting the radar signal from a plurality of transmit antennas 90 configured such that the transmitted radar signal is at least partially canceled at a receive antenna 90, 90B.

Some embodiments of the method 100 further comprise transmitting the radar signal from a plurality of transmit antennas 90 configured for beamforming.

FIG. 8 illustrates a method implemented by a wireless device for receiving and detecting low power spectral density radar signals. The wireless device 10 receives, during radar signal transmission, a reflected radar signal with a front-end circuit 68 configured for below noise, full-duplex radar. The wireless device 10 detects a reflected radar signal in the presence of interference due to the radar signal transmission.

In some embodiments of the method 150, detecting the reflected radar signal received by the RF receiver during radar signal transmission comprises subtracting self-interference due to the radar signal transmission from the reflected radar signal.

In some embodiments of the method 150, receiving a reflected radar signal comprises receiving a combined signal with two or more reflected radar signals.

In some embodiments of the method 150, detecting the reflected radar signal comprises separating the reflected radar signals in the combined signal by successive interference cancellation.

Some embodiments of the method 150 further comprise receiving a combined signal including the communication signal and the reflected radar signal.

In some embodiments of the method 150, detecting the reflected radar signal received by the RF receiver 64 during radar signal transmission comprises extracting the reflected radar signal from the combined signal including the communication signal and the reflected radar signal.

Some embodiments of the method 150 further comprise adjusting a correlation gain for extracting the reflected radar signal from the combined signal based on a received signal power associated with the communication signal.

In some embodiments of the method 150, detecting the reflected radar received by the RF receiver during radar signal transmission comprises subtracting interference due to the transmitted radar signal from the combined signal.

Some embodiments of the method 150 further comprise interrupting radar signal transmission upon detection of a received communication signal.

In some embodiments of the method 150, detecting the reflected radar signal received by the RF receiver during radar signal transmission comprises performing equalization of the received reflected signal to compensate for an estimated frequency transfer function of the front-end circuit.

In some embodiments of the method 150, detecting the reflected radar signal received by the RF receiver during radar signal transmission comprises compensating a transmitted radar signal for an estimated frequency transfer function of the front-end circuit.

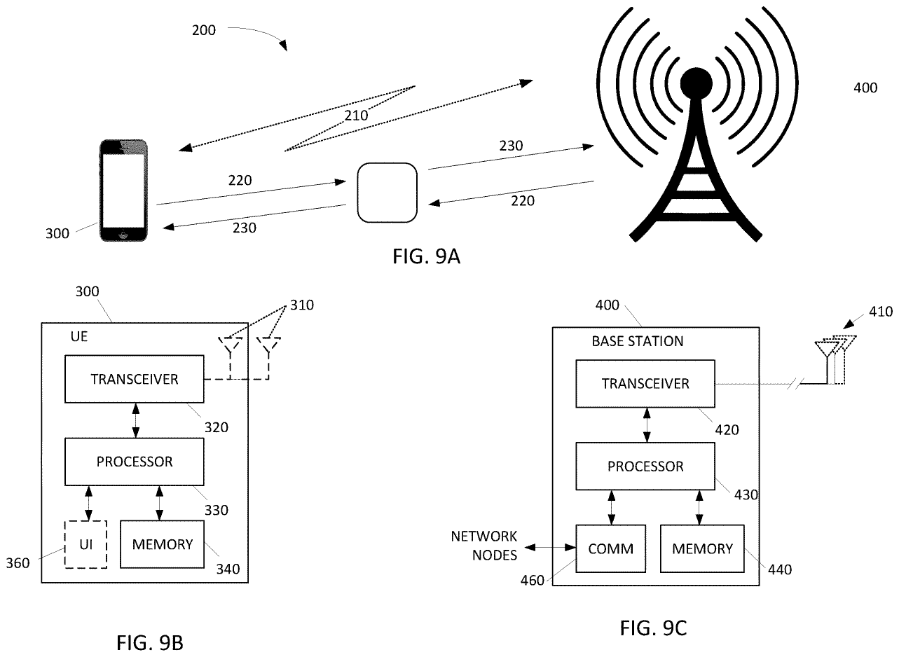

FIG. 9A illustrates an exemplary wireless communication network 200 including one or more wireless devices with radar capability. A user equipment (UE) 300, and base station 400 communicate over a wireless communication channel 210 according to any applicable standard, such as 5G or 6G. In some embodiments, the UE 300 and base station 400 may operate in the millimeter wave frequency bands. The UE 300 and/or base station 400 may also be configured to transmit low power spectral density radar signals in the same frequency bands used for communications and to receive reflected radar signals from objects in the surrounding environment.

FIG. 9B illustrates a user equipment (UE) 300 with radar capability according to an embodiment. As used herein, the term UE may refer to a user-operated telephony terminal, a machine-to-machine (M2M) device, a machine-type communications (MTC) device, a Narrowband Internet of Things (NB-IoT) device (in particular a UE implementing the 3GPP standard for NB-IoT), etc. A UE 300 may also be referred to as a radio device, a radio communication device, a wireless communication device, a wireless terminal, or simply a terminal-unless the context indicates otherwise, the use of any of these terms is intended to include device-to-device UEs or devices, machine-type devices or devices capable of machine-to-machine communication, sensors equipped with a radio network device, wireless-enabled table computers, mobile terminals, smartphones, laptop-embedded equipped (LEE), laptop-mounted equipment (LME), USB dongles, wireless customer-premises equipment (CPE), and the like.

The UE 300 transmits and receives RF signals, which may for example be in the millimeter wave frequency bands, on at least one antenna 310, which may be internal or external, as indicated by dashed lines. The RF signals are generated and received by a transceiver circuit 320. The transceiver circuit is configured to transmit and receive both communication signals and low power spectral density radar signals was previously described. Transceiver circuit 320, as well as other components of the UE 300, are controlled by processing circuitry 330. Memory 340 operatively connected to the processing circuitry 330 stores software in the form of computer instructions operative to cause the processing circuitry 320 to execute various procedures. An optional user interface 360 may include output devices such as a display and speakers (and/or a wired or wireless connection to audio devices such as ear buds), and/or input devices such as buttons, a keypad, a touchscreen, and the like. As indicated by the dashed lines, the user interface 360 may not be present in all UEs 300; for example, UEs 300 designed for Machine Type Communications (MTC) such as Internet of Things (IoT) devices, may perform dedicated functions such as sensing/measuring, monitoring, meter reading, and the like, and may not have any user interface 13608 features.

FIG. 9C illustrates a base station with radar capability according to an embodiment. The base station 400—known in various network implementations as a Radio Base Station (RBS), Base Transceiver Station (BTS), Node B (NB), enhanced Node B (eNB), Next Generation Node B (gNB), or the like—is a node of a wireless communication network that implements a Radio Access Network (RAN) in a defined geographic area called a cell, by providing radio transceivers to communicate wirelessly with a plurality of UEs 300.

The base station 400 transmits and receives RF signals (including MIMO signals), which may for example be in the millimeter wave frequency bands, on a plurality of antennas 410. As indicated by the broken line, the antennas 410 may be located remotely from the base station 400, such as on a tower or building. The RF signals are generated and received by a transceiver circuit 420. The transceiver circuit 420, as well as other components of the base station 400, are controlled by processing circuitry 430. Memory 440 operatively connected to the processing circuitry 430 stores instructions operative to cause the processing circuitry 430 to execute various procedures. Although the memory 440 is depicted as being separate from the processing circuitry 430, those of skill in the art understand that the processing circuitry 430 includes internal memory, such as a cache memory or register file. Those of skill in the art additionally understand that virtualization techniques allow some functions nominally executed by the processing circuitry 430 to actually be executed by other hardware, perhaps remotely located (e.g., at a data center in the so-called “cloud”). Communication circuitry 460 provides one or more communication links to one or more other network nodes, propagating communications to and from UEs 300, from and to other network nodes or other networks, such as telephony networks or the Internet.

Processing circuitry 330, 430 may comprise any sequential state machine operative to execute machine instructions stored as machine-readable computer programs in memory 16, 26, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

Memory 340, 440 may comprise any non-transitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

The transceiver circuits 320, 420 are operative to communicate with one or more other transceivers via a Radio Access Network (RAN) according to one or more communication protocols known in the art or that may be developed, such as IEEE 802.xx, CDMA, WCDMA, GSM, LTE, UTRAN, WiMax, NB-IoT, or the like. The transceiver circuits 320, 420 implement transmitter and receiver functionality appropriate to the RAN links (e.g., frequency allocations and the like). The transmitter and receiver functions may share circuit components and/or software, or alternatively may be implemented separately.

The communication circuitry 460 may comprise a receiver and transmitter interface used to communicate with one or more other nodes over a communication network according to one or more communication protocols known in the art or that may be developed, such as Ethernet, TCP/IP, SONET, ATM, IMS, SIP, or the like. The communication circuits 28 implement receiver and transmitter functionality appropriate to the communication network links (e.g., optical, electrical, and the like). The transmitter and receiver functions may share circuit components and/or software, or alternatively may be implemented separately.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

1-55. (canceled)

56. A front-end circuit for below noise radar in a wireless communication device, the front-end circuit comprising:
a transmit signal path connecting a radio frequency (RF) transmitter to a transmit antenna, the transmit signal path including a power amplifier configured to amplify communication signals output by the RF transmitter during communication signal transmission;
a radar amplifier configured to amplify radar signals output by the RF transmitter during radar signal transmission, wherein:
an input of the radar amplifier is connected to the RF transmitter and the power amplifier; and
an output of the radar amplifier is connected to the antenna through an impedance that reduces an amplitude of the radar signal.

57. The front-end circuit of claim 56, wherein the input of the radar amplifier is connected to the transmit signal path between the RF transmitter and the power amplifier.

58. The front-end circuit of claim 56, wherein the transmit antenna comprises a shared antenna that is shared by the RF transmitter and a RF receiver that is connected to the shared antenna through a receive signal path.

59. The front-end circuit of claim 58, further comprising a duplex switch configured to connect the transmit signal path and receive signal path to the shared antenna, the duplex switch having a first position for connecting the transmit path to the shared antenna and a second position for connecting the receive signal path to the shared antenna.

60. The front-end circuit of claim 59, wherein the output of the radar amplifier is connected through the impedance to the receive signal path in front of the duplex switch.

61. The front-end circuit of claim 60, wherein the duplex switch is configured to be in the second position for radar signal transmission.

62. The front-end circuit of claim 57, wherein the impedance is between about 500 Ohms and about 5000 Ohms.

63. The front-end circuit of claim 57, wherein the impedance is configured to reduce a transmitted radar signal below a signal level threshold at the RF receiver input during radar signal transmission so as to enable simultaneous reception of a communication signal by the RF receiver.

64. The front-end circuit of claim 57 wherein the impedance is configured to reduce a transmitted radar signal below a compression threshold at the RF receiver input during radar signal transmission to reduce compression at the receiver.

65. The front-end circuit of claim 64, wherein the impedance is selected so that reduction of the reflected radar signal due to compression is less than about 3 dB.

66. The front-end circuit of claim 56, wherein the transmit antenna and the receive antenna are different antennas.

67. The front-end circuit of claim 66, wherein the output of the radar amplifier is connected through the impedance to the transmit signal path following the power amplifier.

68. The front-end circuit of claim 67, further comprising a switch connected between the output of the radar amplifier and the impedance, the switch movable between an open position during radar signal transmission and a closed position during communication signal transmission to shunt an output of the radar amplifier to signal ground.

69. The front-end circuit of claim 66, wherein the impedance is configured to reduce a transmitted radar signal below a signal level threshold at an input to the transmit antenna during radar signal transmission so as to enable simultaneous reception of a communication signal.

70. The front-end circuit of claim 57, wherein the front-end circuit is configured to receive a reflected radar signal simultaneously during radar signal transmission.

71. The front-end circuit of claim 70, comprising a plurality of transmit antennas configured to transmit a radar signal and a receive antenna configured to receive a reflected radar signal, wherein the transmit antennas are configured such that the transmitted radar signal by the plurality of transmit antennas is at least partially canceled at the receive antenna.

72. A method implemented in a wireless communication device with radar capability of transmitting a low power spectral density radar signal, the method comprising:
in a communication mode, coupling a communication signal output by a RF transmitter to a transmit antenna through a transmit signal path including a power amplifier; and
in a radar mode, coupling a radar signal output by the RF transmitter to the transmit antenna through a radar amplifier having an input connected to the transmit signal path in front of the power amplifier and an output connected to the transmit antenna through an impedance, wherein the impedance is configured to reduce an amplitude of the radar signal.
